(19) United States
(12) Patent Application Publication
(10) Pub. No.: US 2016/0059511 A1
(43) Pub. Date: Mar. 3, 2016

(54) TRANSFER FILM AND METHOD FOR FABRICATING AN EMOBOSSED UNIT

(71) Applicant: INHON INTERNATIONAL CO., LTD., TAIPEI CITY (TW)

(72) Inventors: Hong Fan Wei, Taipei City (TW); Cho-Yi Lin, Taipei City (TW); Yushu Hsu, Taipei City (TW)

(21) Appl. No.: 14/475,909

(22) Filed: Sep. 3, 2014

(51) Int. Cl. B32B 3/26; B32B 38/06; B32B 27/36

(52) U.S. Cl. CPC B32B 3/263; B32B 27/36; B32B 38/06

(57) ABSTRACT

A transfer film having texture and fragrance, and a method for fabricating an embossed unit using the transfer film via in-mold lamination or in-mold injection are disclosed. The transfer film has a PET layer, a release layer, an embossed layer disposed there between, and a plurality of microcapsules. The embossed layer has a first layer and a second layer respectively affixed to the PET layer and the release layer, the second surface is formed with a convex-concave texture, and the release layer has a third surface away from the embossed layer also formed with the convex-concave texture. A UV material layer, an ink layer and an adhesive layer are further disposed below the third surface. Furthermore, the plurality of microcapsules can be coated on the third surface or be dispersed in the UV material layer.

### FIELD OF THE INVENTION

The present invention is related to the technical field of surface treatment on a plastic base, and, in particular, to a transfer film with convex-concave texture and fragrance, and a method for fabricating an embossed unit by using the transfer film.

### BACKGROUND OF THE INVENTION

In-mold pattern transfer technology often uses molding machines to transfer ink patterns printed on a transfer film in a mold cavity during an injection molding process. In the past, to provide an appearance unit with convex-concave texture on a surface of a plastic material base, the injection mold had to be etched by electrical discharge processing in advance. Therefore, one single injection mold could only be used to obtain a single convex-concave texture, and different sets of injection molds were required for different convex-concave textures.

A Chinese patent application, numbered 200810241686.8, discloses a forming method of an in-mold embossed unit, which comprises the steps of: providing a transfer film with an embossed photo-cured glue on a first surface thereof, disposing the transfer film in the molding machine, injecting the plastic material base on the first surface, and detaching the transfer film to obtain the embossed unit.

However, by adopting the above method, it is difficult to detach the sheet and the base material. Therefore, the conventional art needs extra heat to detach the base material from the sheet. The texture is easily deformed or damaged during the heating procedure. Some shortcomings of the conventional art are high production cost, low production efficiency, fragile surface of the mold cavity, and short lifetime of the molding machine. Once the surface of the mold cavity is damaged, the repairing time is long, and the surface of the mold cavity is not guaranteed to remain in the original texture pattern.

Moreover, the conventional in-mold pattern transfer technology can only provide a product with a visual or tactile sensation of patterns and textures, but never provide tactile and olfactory sensations in one product.

Therefore, it is necessary to provide a new product, such as an embossed unit, and a method for fabricating the embossed unit by using a new transfer film to solve the above problem.

### SUMMARY OF THE INVENTION

To solve the above problem, one objective of the present invention is to provide a transfer film having texture and fragrance to improve the tactile and olfactory sensations of the conventional transfer film. The transfer film of the present invention comprises: a PET layer, a release layer, and an embossed layer disposed there between, where the embossed layer has a first surface and a second surface respectively affixed to the PET layer and the release layer, the second surface is formed with a convex-concave texture, the release layer has a third surface far away from the embossed layer also formed with the convex-concave texture.

The transfer film further comprises a plurality of microcapsules. The plurality of microcapsules are fragrance microcapsules, which can be coated on the third surface, or be dispersed in the UV material layer.

Another objective of the present invention is to provide a method for fabricating an embossed unit by adopting the above mentioned transfer films.

According to the present invention, the embossed unit is fabricated by the following steps: (1) preparing a transfer film as described above; (2) positioning the transfer film in a mold cavity of an injection molding apparatus; (3) injecting a plastic base into the mold cavity; (4) curing the plastic base, and affixing the plastic base to the transfer film at the same time; and (5) peeling off the transfer film from the release layer after opening the mold cavity to obtain the embossed unit.

According to the present invention, the embossed unit can also be fabricated by the following steps: (1) preparing a transfer film as described above; (2) laminating the transfer film on a surface of a formed plastic base by using a laminating apparatus, and then affixing the transfer film to the plastic base; and (3) peeling off the transfer film from the release layer after the laminating is finished to obtain the embossed unit.

Compared to the conventional art, the beneficial effects of the present invention are: a transfer film with convex-concave texture can be transferred to a surface of a plastic base, and then be peeled off from the plastic base via a release layer, such that by replacing the transfer film with different textures, patterns, or fragrances, different embossed units can be produced with one single mold, instead of using different molds. Therefore, the embossed unit not only can achieve diversification tactile and olfactory sensations that the conventional art cannot provide, but also can save a lot of time on mold opening and mold repairing, the versatility is high, and the cost is greatly reduced.

For a better understanding of the aforementioned content of the present invention, preferable embodiments are illustrated in accordance with the attached figures as follows:

### BRIEF DESCRIPTION OF THE DRAWINGS

FIG. 1 is a schematic cross-sectional diagram of a transfer film in accordance with one embodiment provided by the present invention;

FIG. 2 is a schematic cross-sectional diagram of a transfer film in accordance with another embodiment provided by the present invention;

FIG. 3 is an exemplary method of fabricating an embossed unit by affixing a transfer film to a plastic base;

FIG. 4 is a schematic cross-sectional diagram of an embossed unit provided by the present invention;

FIG. 5 is an exemplary method of fabricating an embossed unit by affixing another transfer film to a plastic base;

FIG. 6 is a schematic cross-sectional diagram of another embossed unit provided by the present invention.

### DETAILED DESCRIPTION OF THE PREFERRED EMBODIMENTS

Please refer to the drawings, in which similar components are represented by the same component symbol. The principles of the present invention are implemented in a suitable embodiment. The following description is based on illustrated specific embodiments of the present invention, which should not be construed as limitations for other specific embodiments that are not discussed in the present invention.

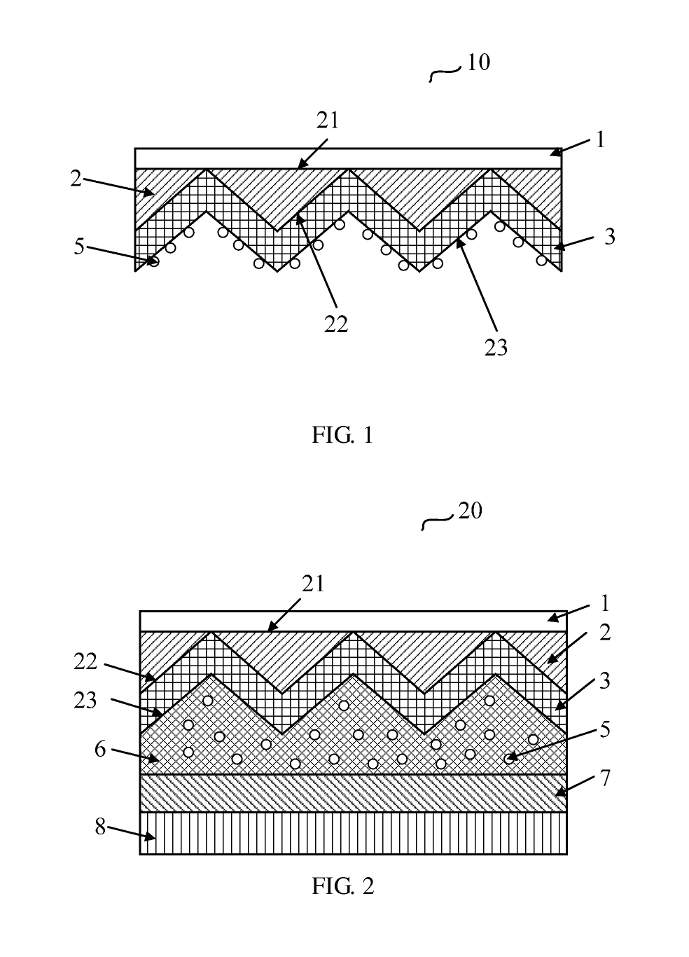

FIG. 1 is a schematic cross-sectional diagram of a transfer film in accordance with one embodiment of the present invention. In this embodiment, a transfer film 10 comprising a PET layer 1, a release layer 3, and an embossed layer 2 disposed there between, wherein the embossed layer 2 has a first surface 21 and a second surface 22 respectively affixed to the PET layer 1 and the release layer 3, the second surface 22 is formed with a convex-concave texture, and the release layer 3 has a third surface 23 far away from the embossed layer 2 and also formed with the convex-concave texture.

According to an embodiment of the present invention, the PET layer 1 has a thickness of about 38 um-78 um; the embossed layer 2 has a thickness of about 0.005 mm-0.1 mm; and the release layer 3 has a thickness of about 0.005 mm-0.02 mm.

According to the embodiment, the embossed layer 2 is a UV curable layer. The UV curable layer may comprise light curable materials that are completely cured under ultraviolet rays, such as a single liquid coating material. PET represents polyethylene terephthalate.

According to an embodiment of the present invention, the second surface 22 has a plurality of coarse regions and a plurality of smooth regions, the coarse regions are constructed by the convex-concave texture, while the smooth regions are constructed without the convex-concave texture. The coarse regions can be further divided into a relative smooth portion and a relative coarse portion. A roughness of the relative coarse portion is greater than that of the relative smooth portion.

Alternately, the second surface 22 is a coarse region constructed by the convex-concave texture. The coarse region can be further divided into a relative smooth portion and a relative coarse portion. A roughness of the relative coarse portion is greater than that of the relative smooth portion.

That is, the second surface 22 is a surface with the convex-concave texture on selected regions, or a surface entirely covered with the convex-concave texture. Accordingly, the third surface 23 coinciding with the second surface 22 also has the same convex-concave texture on selected regions, or is entirely covered with the convex-concave texture.

Since the convex-concave texture is a stereoscopic structure, the tactile sensation can be improved. Furthermore, since the reflection of the coarse region and the smooth region are different, a visual effect of a dark region and a bright region is thereby generated by the coarse region and smooth region, respectively.

Furthermore, the transfer film further comprises a plurality of microcapsules 5 coated on the third surface 23 of the release layer 3. The microcapsules 5 comprise a shell and a filling material, wherein the shell comprises a material selected from a group consisting of gelatin, arabic gum, shellac, starch, dextrin, wax, resin, sodium alginate, and corn plastic, or a group consisting polyethylene, polystyrene, polybutadiene, polypropylene, polyethylene glycol, polyvinyl alcohol, polyamide, polymethyl methacrylate, polyacrylamide, polyurethane, epoxy resin, polysiloxane alkyl, polyether, polyurea, and polyvinyl pyrrolidone. The filling material comprises a fragrance ingredient, and the fragrance ingredient may be one single ingredient or more than one ingredients mixed inside the microcapsules 5. The fragrance ingredient is not limited in the present invention.

According to an embodiment of the present invention, the microcapsules 5 have an average diameter of 3-30 um, and a thickness of the microcapsules 5 is about 1 um. The fragrance ingredient is present in an amount of from 3 to 30% by weight relative to the total weight of the microcapsules.

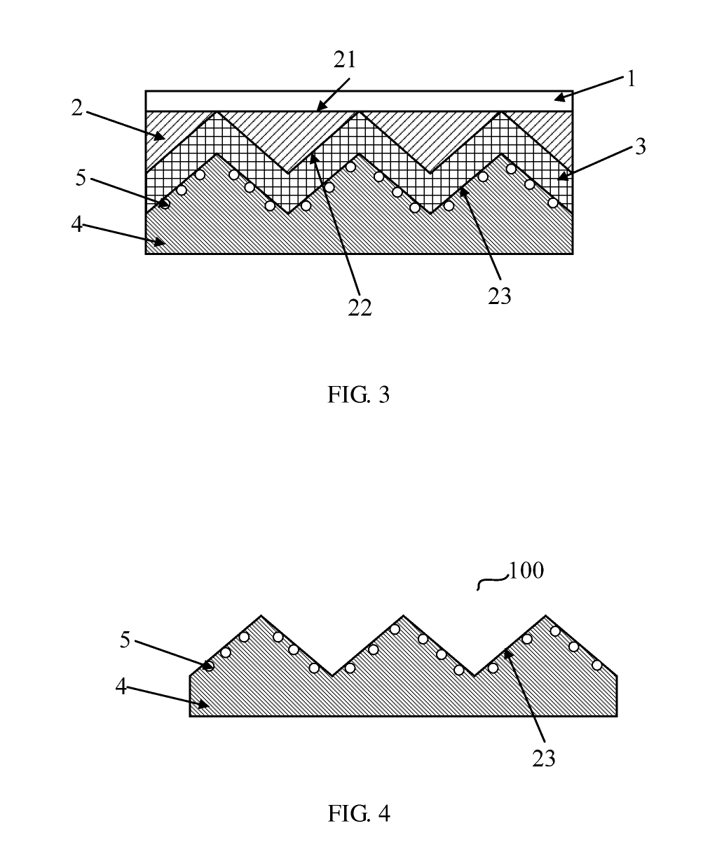

As shown in FIGS. 3 and 4, when the transfer film 10 is affixed to a plastic member 4, the convex-concave texture and the plurality of microcapsules 5 on the third surface 23 are transferred to the plastic member 4 via an in-mold lamination or an in-mold injection process. Thus, an embossed unit 100 is obtained. Furthermore, by scratching or pressing the external surface of the embossed unit 100, the fragrance ingredient in the microcapsules 5 may be released.

FIG. 2 is a transfer film in accordance with another embodiment provided by the present invention. The transfer film 20 further comprises an UV material layer 6, an ink layer 7, and an adhesive layer 8 sequentially disposed below the third surface 23. That is, a transfer film 20 sequentially comprises a PET layer 1, an embossed layer 2, a release layer 3, a UV material layer 6, an ink layer 7, and an adhesive layer 8. According to the embodiments, transfer film further comprises a plurality of microcapsules 5 dispersed in the UV material layer 6.

According to an embodiment of the present invention, the PET layer 1 has a thickness of about 38 um-78 um, the embossed layer 2 has a thickness of about 0.005 mm-0.1 mm, the release layer 3 has a thickness of about 0.005 mm-0.02 mm, and the UV material layer 6 has a thickness of about 0.05 mm-0.4 mm. The thicknesses of the ink layer 7 and the adhesive layer 8 are not limited in the present invention.

As mentioned above, the embossed layer 2 is a UV curable layer, which may comprise light curable materials that are completely cured under ultraviolet rays, such as a single liquid coating material. The UV material layer 6 in the present embodiment, for example, may include a thermal-setting or a semi-thermal setting coating.

According to this embodiment, the second surface 22 has a plurality of coarse regions and a plurality of smooth regions, and the coarse regions are constructed by the convex-concave texture, while the smooth regions are constructed without the convex-concave texture. The coarse regions can be further divided into a relative smooth portion and a relative coarse portion. A roughness of the relative coarse portion is greater than that of the relative smooth portion.

Alternately, the second surface 22 is a coarse region constructed by the convex-concave texture. The coarse region can be further divided into a relative smooth portion and a relative coarse portion. A roughness of the relative coarse portion is greater than that of the relative smooth portion.

That is, the second surface 22 is a surface with the convex-concave texture on selected regions, or a surface entirely covered with the convex-concave texture. Accordingly, the third surface 23 coinciding with the second surface 22 also has the same convex-concave texture on selected regions, or is entirely covered with the convex-concave texture.

Since the convex-concave texture is a stereoscopic structure, the tactile sensation can be improved. Furthermore, since the reflection of the coarse region and the smooth region are different, a visual effect of a dark region and a bright region is thereby generated by the coarse region and smooth region, respectively.

Accordingly, the microcapsules 5 of the present embodiment comprise a shell and a filling material, which may be released from the microcapsules 5 by scratching or pressing the external surface of the embossed unit 200. The size, the shell material, the filling material, and the concentration of the filling material are the same as mentioned above, which will not be described herein.

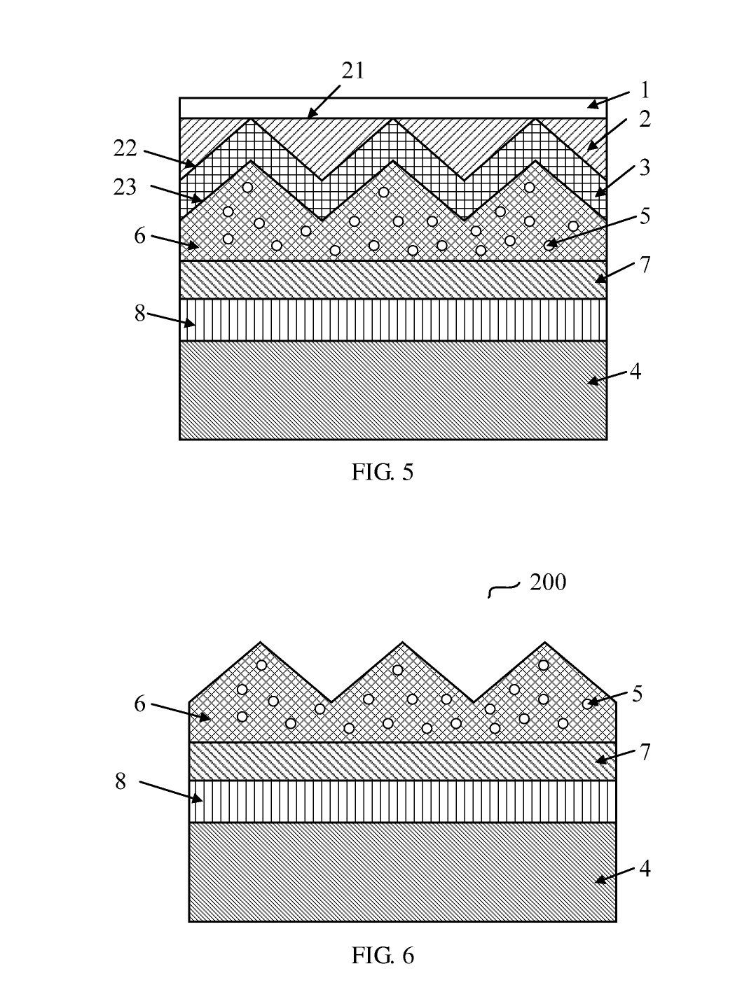

As shown in FIGS. 5 and 6, since the transfer film 20 comprise the convex-concave texture on the second surface 22 of the embossed layer 2, when the transfer film 20 is affixed to a plastic member 4, the convex-concave texture is transferred to the UV material layer 6 via an in-mold lamination or an in-mold injection process. At the same time, the fragrance microcapsules 5 dispersed in the UV material layer 6 together with the convex-concave texture combined with a pattern on the ink layer 7 are formed on the plastic base 4, and thereby an embossed unit 200 is obtained. Furthermore, by scratching or pressing the external surface of the embossed unit 200, the fragrance ingredient in the microcapsules 5 may be released. The pattern of the convex-concave texture, and the pattern of the ink layer 7 are not limited in the present invention; the pattern can be designed according to different appearance requirements of the embossed unit 200.

An exemplary method of fabricating an embossed unit 100, 200 with concave-convex texture is provided. By affixing the transfer film 10, 20 to the plastic base 4 in combination with the in-mold injection technique comprises the steps of:

Step (1) preparing a transfer film 10, 20; step (2) positioning the transfer film 10, 20 in a mold cavity of an injection molding apparatus; step (3) injecting a plastic base 4 into the mold cavity; step (4) curing the plastic base 4, and affixing the plastic base 4 to the transfer film 10, 20 at the same time; and step (5) peeling off the transfer film 10, 20 from the release layer 3 after opening the mold cavity to obtain the embossed unit 100, 200, as shown in FIGS. 4 and 6.

The plastic base 4 used herein may be polycarbonate and acrylonitrile butadiene styrene (PC/ABS), or glass filled polyamide (PA/GF).

In particular, as shown in FIGS. 3 and 4, when the transfer film 10 is used, the above step (1) further comprises the steps of: step (1-1) fabricating a moldboard having a surface with a convex-concave texture; step (1-2) coating a UV curable material on the surface with the convex-concave texture; step (1-3) coating a PET layer 1 on the UV curable material; step (1-4) laminating the moldboard with the coated UV curable material and the PET layer 1, and exposing to UV light for curing the UV curable material to a UV cured layer 2; step (1-5) detaching the moldboard and the UV cured layer 2, the UV cured layer 2 is laminated with the PET layer 1; and step (1-6) laminating a release layer 3 on the UV cured layer 2; and step (1-7) coating a plurality of microcapsules 5 on a surface of the release layer 3 opposite the UV cured layer 2 to obtain the transfer film 10.

According to this embodiment, when the plastic base 4 is affixed to the transfer film 10, i.e., the third surface 23 of release layer 3, the convex-concave texture and the fragrance microcapsules 5 on the third surface 23 is therefore transferred to the plastic base 4 via the above curing step (4). After finishing the step (5), the embossed unit 100 is obtained.

Alternatively, as shown in FIGS. 5 and 6, when the transfer film 20 is used, the above step (1) further comprises the steps of: step (1-1) fabricating a moldboard having a surface with a convex-concave texture; step (1-2) coating a first UV curable material on the surface with the convex-concave texture; step (1-3) coating a PET layer 1 on the first UV curable material; step (1-4) laminating the moldboard with the coated first UV curable material and the PET layer 1, and exposing to UV light for curing the first UV curable material to a first UV cured layer 2; step (1-5) detaching the moldboard and the first UV cured layer 2, the first UV cured layer 2 is laminated with the PET layer 1; and step (1-6) laminating a release layer 3, a second UV cured layer 6, an ink layer 7, and an adhesive layer 8, sequentially onto the second UV cured layer 6 to obtain the transfer film 20.

According to the alternative embodiment, when the plastic base 4 is affixed to the transfer film 10, the convex-concave texture formed on the third surface 23 is therefore transferred to the UV material layer 6 via the above curing step (4), with the fragrance microcapsules 5 dispersed in the UV material layer 6, the ink layer 7 having patterns, and the adhesive layer 8 all affixed to the plastic base 4. After finishing the step (5), the embossed unit 200 is obtained.

The embossed unit 100, 200 can also be fabricated by another exemplary method of affixing the transfer film 10, 20 to the plastic base 4 in combination with the in-mold lamination technique. According to this embodiment, the embossed unit 100, 200 is obtained by the following steps: (1) preparing a transfer film 10, 20; (2) laminating the transfer film 10, 20 on a surface of a formed plastic base 4 by using a laminating apparatus, and then affixing the transfer film 10, 20 to the plastic base 4; (3) peeling off the transfer film 10, 20 from the release layer 3 after finishing the laminating to obtain the embossed unit 100, 200, as shown in FIGS. 4 and 6.

According to this embodiment, the step (1) comprises the steps as mentioned above, which will not be described herein.

Accordingly, as shown in FIGS. 3 and 4, when the transfer film 10 is used, the plastic base 4 is affixed to the release layer 3 having the fragrance microcapsules 5, after peeling off the transfer film 10 from the release layer 3, the plastic base 4 carrying the concave-convex texture and the fragrance microcapsules 5, and particularly the embossed unit 100, is obtained. Similarly, as shown in FIGS. 5 and 6, when the transfer film 20 is used, the plastic base 4 is affixed to the adhesive layer 8 of the transfer film 20, after peeling off the transfer film 10 from the release layer 3, the UV material layer 6 carrying the concave-convex texture and the fragrance microcapsules 5 together with the ink layer 7 and the adhesive layer 8 is bonded to the plastic base 4, and thereby the embossed unit 200 is obtained.

The present invention provides a transfer film and a method of making an embossed unit. By adopting a transfer film with different textures or patterns and different fragrances to meet different needs of the embossed unit. Since a transfer film with different textures or fragrances can be replaced in the in-mold injection or lamination apparatuses, the different embossed units can be obtained in one single mold, the diversification can be achieved and the production cost can be decreased.

The embodiments were chosen and described in order to explain the principles of the disclosure and their practical application so as to activate others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims, rather than the foregoing description and the exemplary embodiments described therein.

What is claimed is:

1. A transfer film comprising:
a PET (polyethylene terephthalate) layer;
a release layer;
an embossed layer disposed between the PET layer and the release layer;
wherein the embossed layer has a first surface and a second surface respectively affixed to the PET layer and the release layer, the second surface is formed with a convex-concave texture, and the release layer has a third surface far away from the embossed layer also formed with the convex-concave texture.

2. The transfer film as claimed in claim 1, further comprising a plurality of microcapsules coated on the third surface.

3. The transfer film as claimed in claim 1 further comprising a UV (ultraviolet) material layer, an ink layer, and an adhesive layer sequentially disposed below the third surface.

4. The transfer film as claimed in claim 3, further comprising a plurality of microcapsules dispersed in the UV material layer.

5. The transfer film as claimed in claim 1, wherein, the second surface has a plurality of coarse regions and a plurality of smooth regions, the coarse regions are constructed by the convex-concave texture, the smooth regions are constructed without the convex-concave texture.

6. The transfer film as claimed in claim 2, wherein, the second surface has a plurality of coarse regions and a plurality of smooth regions, the coarse regions are constructed by the convex-concave texture, the smooth regions are constructed without the convex-concave texture.

7. The transfer film as claimed in claim 3, wherein, the second surface has a plurality of coarse regions and a plurality of smooth regions, the coarse regions are constructed by the convex-concave texture, the smooth regions are constructed without the convex-concave texture.

8. The transfer film as claimed in claim 5, wherein, the coarse regions can be further divided into a relative smooth portion and a relative coarse portion, and a roughness of the relative coarse portion is greater than that of the relative smooth portion.

9. The transfer film as claimed in claim 1, wherein the second surface is a coarse region constructed by the convex-concave texture.

10. The transfer film as claimed in claim 2, wherein the second surface is a coarse region constructed by the convex-concave texture.

11. The transfer film as claimed in claim 3, wherein the second surface is a coarse region constructed by the convex-concave texture.

12. The transfer film as claimed in claim 9, wherein, the coarse region can further be divided into a relative smooth portion and a relative coarse portion, and a roughness of the relative coarse portion is greater than that of the relative smooth portion.

13. The transfer film as claimed in claim 1, wherein the embossed layer is an UV curable layer.

14. The transfer film as claimed in claim 1, wherein the PET layer has a thickness of about 38 um-78 um, the embossed layer has a thickness of about 0.005 mm-0.1 mm, and the release layer has a thickness of about 0.005 mm-0.02 mm.

15. The transfer film as claimed in claim 3, wherein the PET layer has a thickness of about 38 um-78 um, the embossed layer has a thickness of about 0.005 mm-0.1 mm, the release layer has a thickness of about 0.005 mm-0.02 mm, and the UV material layer has a thickness of about 0.05 mm-0.4 mm.

16. The transfer film as claimed in claim 2, wherein the plurality of microcapsules comprising a shell and a filling material, wherein the shell comprises a material selected from a group consisting of gelatin, arabic gum, shellac, starch, dextrin, wax, resin, sodium alginate, and corn plastic, or a group consisting polyethylene, polystyrene, polybutadiene, polypropylene, polyethylene glycol, polyvinyl alcohol, polyamide, polymethyl methacrylate, polyacrylamide, polyurethane, epoxy resin, polysiloxane alkyl, polyether, polyurea, and polyvinyl pyrrolidone.

17. The transfer film as claimed in claim 16, wherein, the filling material comprises a fragrance ingredient, the fragrance ingredient is present in an amount of 3-30% by weight relative to the total weight of the microcapsules.

18. The transfer film as claimed in claim 16, wherein the microcapsules have an average diameter of 3-30 um, and a thickness of the shell is about 1 um.

19. A method for fabricating an embossed unit comprising steps of:
(1) preparing a transfer film as claimed in claim 1;
(2) positioning the transfer film in a mold cavity of an injection molding apparatus;
(3) injecting a plastic base into the mold cavity;
(4) curing the plastic base, and affixing the plastic base to the transfer film at the same time; and
(5) peeling off the transfer film from the release layer after opening the mold cavity to obtain the embossed unit.

20. A method for fabricating an embossed unit comprising steps of:
(1) preparing a transfer film as claimed in claim 1;
(2) laminating the transfer film on a surface of a formed plastic base by using a laminating apparatus, and then affixing the transfer film to the plastic base; and
(3) peeling off the transfer film from the release layer after the laminating is finished to obtain the embossed unit.
